(19) United States
(12) Patent Application Publication
(10) Pub. No.: US 2011/0099508 A1
(43) Pub. Date: Apr. 28, 2011

(54) MOBILE DEVICE AND METHOD FOR OPERATING A USER INTERFACE OF THE MOBILE DEVICE

(75) Inventor: CHENG-HAN LIU, Tu-Cheng (TW)

(73) Assignee: HON HAI PRECISION INDUSTRY CO., LTD., Tu-Cheng (TW)

(21) Appl. No.: 12/628,315

(22) Filed: Dec. 1, 2009

(30) Foreign Application Priority Data
Oct. 22, 2009 (CN) 200910308670.9

(51) Int. Cl. G06F 3/048

(52) U.S. Cl. 715/781

(57) ABSTRACT

A mobile device and a method for operating the mobile device are provided. The method initializes the mobile device to support a multitasking environment, and synchronously executing multiple software applications in the multitasking environment. The method generates a user interface on a home screen of the mobile device, and divides the user interface into multiple display areas according to a total number of the executed software applications. The method receives an input command from a keypad of the mobile device, and generates a key input event according to the input command. In addition, the method controls different software applications to communicate with each other according to the key input event, and displays an execution result of each of the executed software applications on a corresponding display area of the user interface.

### BACKGROUND

1. Technical Field

Embodiments of the present disclosure relate generally to mobile devices and methods for operating the mobile devices, and more particularly to a mobile device and a method for operating a user interface of the mobile device.

2. Description of Related Art

Mobile devices, such as mobile phones or personal digital assistants, are typically limited in display size. Menus are commonly used for navigation of a user interface system on a display of a mobile device. Typically, a user is first presented with an introductory user interface, often called a main menu that provides the user with a set of selectable options. Selecting an option may take the user to another user interface, or submenu. For example, a first-level menu, including a set of selectable options, may be linked to a plurality of second-level menus that may include another set of selectable options. The selectable options on the second-level menus may be linked to a plurality of third-level menus, which may include another set of selectable options that may be linked to a set of fourth-level menus, and so on.

In the conventional user interface system, in order to complete a task, a user must access a single icon in a deep menu tree. Therefore, a lot of time consuming, confusing, and tedious click actions must be performed by the user. In addition, windows may overlap with each other when two functions are needed to complete a task.

Accordingly, there is a need for an improved method for operating a user interface of the mobile device, so as to overcome the above-mentioned problems.

### BRIEF DESCRIPTION OF THE DRAWINGS

FIG. 1 is a schematic diagram of one embodiment of a mobile device.

FIG. 2a-2b shows a schematic diagram illustrating a home screen of the mobile device.

FIG. 3 is a flowchart of one embodiment of a method for operating a user interface of the mobile device of FIG. 1.

FIG. 4a-4c shows a schematic diagram illustrating one example of a user interface on the home screen of the mobile device.

FIG. 5a-5c shows a schematic diagram illustrating another example of a user interface on the home screen of the mobile device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

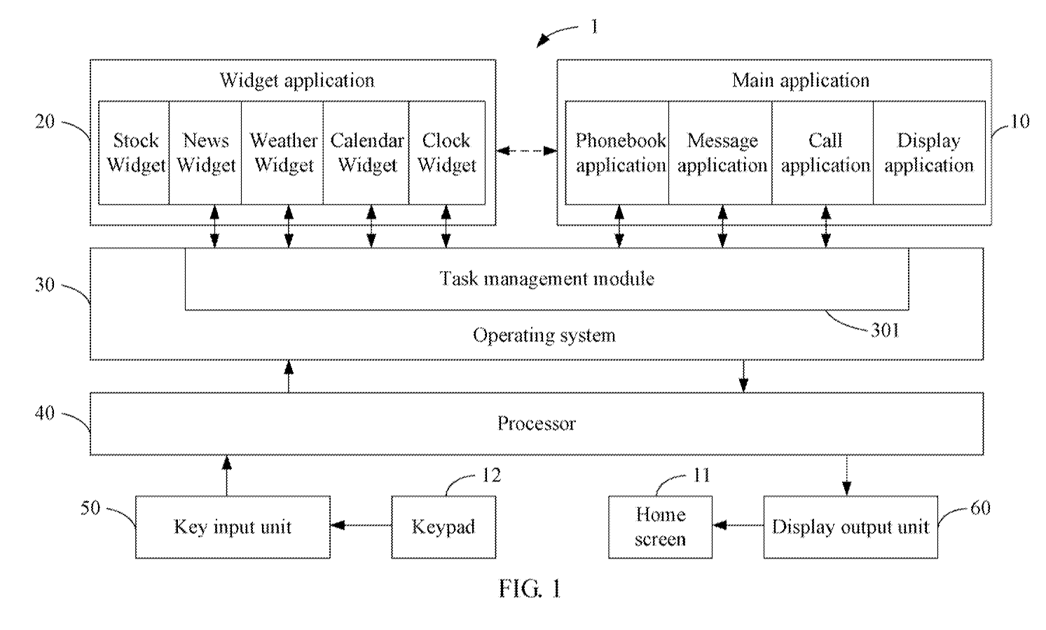

FIG. 1 is a schematic diagram of one embodiment of a mobile device 1. In the embodiment, the mobile device 1 can support a multitasking environment to execute multiple software applications synchronously. The mobile device 1 may be a mobile phone, a personal digital assistant (PDA), or a mobile communication terminal. The software applications may include a plurality of main applications 10 and widget applications 20. The main applications 10 may include a phonebook application, a message application, a call application, a display application, for example. The widget applications 20 may include a clock widget, a calendar widget, a weather widget, a news widget, a stock widget, for example. Each of the widget applications 20 can be downloaded from a website and installed in the mobile device 1, or programmed by a designer using a programming language, such as XML or JavaScript. Each of the widget applications 20 can be both customizable and extensible to allow a user to access and share data and tasks relevant to the mobile device 1.

The mobile device 1 may further include an operating system (OS) 30, a processor 40, a key input unit 50, a display output unit 60, a home screen 11, and a keypad 12. The operating system 30 includes a task management module 301, which is operable to support a multitasking environment to execute multiple software applications synchronously, and control one of the software applications to communicate with other software applications. For example, if a widget icon is displayed on the home screen 11, the task management module 301 drives a stock widget event to execute the stock widget when the widget icon is selected. Then the task management module 301 copies an execution result (e.g., stock information) of the stock widget, and sends the execution result to the display application. As such, the display output unit 60 displays the stock information on the home screen 11 of the mobile device 1.

The processor 40 is operable to execute the main applications 10 and the widget applications 20 through the operating system 30, and initialize hardware of the mobile device 1, such as the home screen 11 and the keypad 12. The key input unit 50 is configured to receive an input command from the keypad 12, and send the input command to the processor 40 to generate a key input event. The display output unit 60 is configured to generate a user interface on the home screen 11, divide the user interface into a plurality of display areas according to a total number of the executed applications, and display an execution result of each of the executed applications on one of the display areas. The keypad 12 includes a plurality of direction selectable keys and numerical keys. The selectable direction keys may include an up key, a down key, a left key, and a right key.

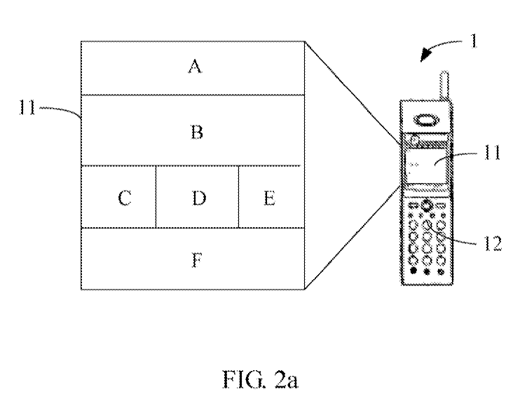

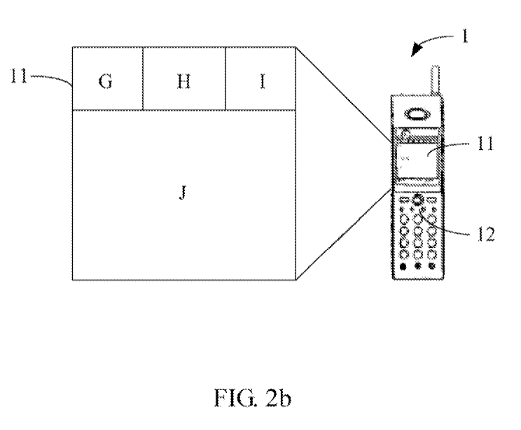

FIG. 2 is a schematic diagram illustrating the home screen 11 of the mobile device 1. In one embodiment, a user interface of the home screen 11 is divided into a plurality of display areas by the display output unit 60. The display areas can be arranged on the user interface horizontally, vertically, or both horizontally and vertically depending on the embodiment. In one example with respect to FIG. 2a, the user interface of the home screen 11 is divided into display areas A, B, C, D, E and F. In another example with respect to FIG. 2b, the user interface of the home screen 11 is divided into display areas G, H, I, and J. When multiple software applications are executed, a set of groups (e.g., application icons or items) can be displayed on each of the display areas of the user interface. The set of groups can provide a user with a converged view to activate functions and combine data between different software applications. This arrangement makes it easier for a user to access and share subsets of data and tasks available on the mobile device 1.

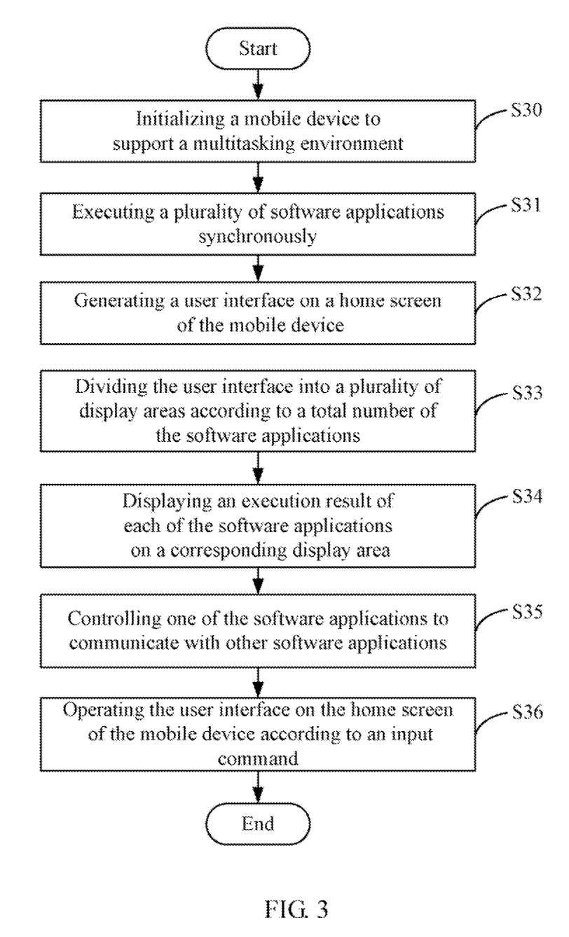

FIG. 3 is a flowchart of one embodiment of a method for operating a user interface of the mobile device 1 as described in FIG. 1. Depending on the embodiment, additional blocks may be added, others removed, and the ordering of the blocks may be changed. The mobile device 1 can execute multiple software applications synchronously, and set a group of data and function items on an improved user interface of the home screen 11. The software applications may include the main applications 10 and the widget applications 20.

In block S30, the processor 40 initializes hardware of the mobile device 1, such as the home screen 11 and the keypad 12, and drives the task management module 301 of the operating system 30 to support a multitasking environment.

In block S31, the task management module 301 synchronously executes multiple software applications in the multitasking environment. For example, a meeting schedule application is executed with a calendar widget, and a weather forecast provided by a weather widget.

In block S32, the display output unit 60 generates a user interface on the home screen 11. In block S33, the display output unit 60 divides the user interface into a plurality of display areas according to a total number of the executed applications. In one embodiment, the display areas can be arranged on the user interface horizontally, vertically, or both horizontally and vertically. In one example with respect to FIG. 2a, the user interface of the home screen 11 is divided into display areas A, B, C, D, E and F. In another example with respect to FIG. 2b, the user interface of the home screen 11 is divided into display areas G, H, I, and J.

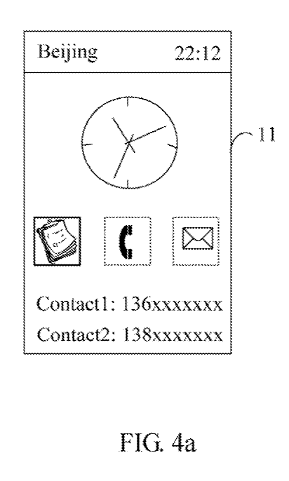

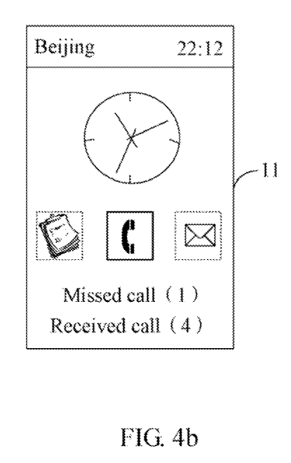

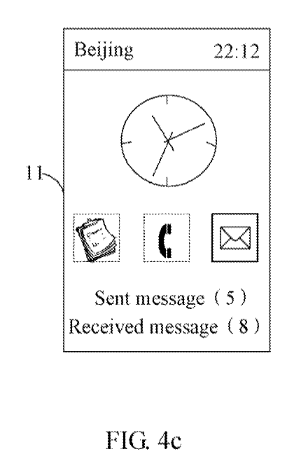

In block S34, the display output unit 60 displays an execution result of each of the executed software applications on one of the display areas of the home screen 11. The execution result may be a group of application icons or function items, and can provide a user with a converged view to activate functions and combine data between different software applications. In one example with respect to FIG. 4a, a clock icon is displayed on a first display area of the home screen 11, such as display area B shown in FIG. 2a. Beijing time (e.g., 22:12 o'clock) is displayed a second display area of the home screen 11, such as display area A shown in FIG. 2a. In addition, a phonebook icon is displayed on a third display area of the home screen 11, such as display area C shown in FIG. 2a. When the user selects the phone book icon, the phonebook application is executed and displays phone numbers of contact persons on a fourth display area, such as display area D shown in FIG. 2a.

In block S35, the task management module 301 controls one of the software applications to communicate with the other software applications. For example, if a widget icon is displayed on the home screen 11, the task management module 301 drives a stock widget event to execute the stock widget when the widget icon is selected. Then the task management module 301 copies an execution result (e.g., stock information) of the stock widget, and sends the execution result to the display application. As such, the display output unit 60 displays the stock information on the home screen 11 of the mobile device 1.

In block S36, the user selects each of the application icons of the user interface to execute a set of software applications by operating the keypad 12. In one embodiment, a customizable set of each application icon can be defined to allow the user to quickly access and share relevant content such as commonly used data or tasks. The user can add, delete, record and/or edit groups to personalize and increase usability of the mobile device. For example, the user can define a first group to manage calendar events, and a second group to manage instant messages. Data in a calendar application can be updated based upon a specific user selection on the user interface. In addition, the user can share the data via instant messaging.

FIG. 4a-4c show schematic diagrams illustrating one example of a user interface displayed on the home screen 11 of the mobile device 1. In the example, the mobile device 1 may synchronously execute a clock widget, a phonebook application, a call application, and a message application. Therefore, a set of application icons, including a clock icon, a phonebook icon, a call icon, and a message icon, are displayed on the user interface of the home screen 11. The set of application icons can provide users with a converged view on the user interface of the home screen 11. While the full extent of underlying software applications remains available through the applications, the set of lists can enhance usability by providing a user with the ability to quickly access the most relevant or commonly used data or tasks. For example, a user may have data for hundreds of contacts stored in an address book of the mobile device 1. However, the user typically communicates with only ten of those contacts on a daily basis. Those ten contacts can be maintained in a contact group from the home screen 11. Information for the ten contacts can be accessed directly from the home screen 11 rather than through the phonebook application.

Referring to FIG. 4a-4c, a clock icon is displayed on a first display area of the home screen 11, such as display area B shown in FIG. 2a. Beijing time (e.g., 22:12 o'clock) is displayed a second display area of the home screen 11, such as display area A shown in FIG. 2a. Referring to FIG. 4a, the information list of contact persons is displayed on the user interface of the home screen 11 when the phonebook icon is selected. For example, a phone number of a contact person is “136xxxxxxxxx,” a phone number of another contact person is “138xxxxxxxxxx,” and etc. Referring to FIG. 4b, a call list available in the mobile device 1 is displayed on the user interface of the home screen 11 when the call icon is selected. For example, the call list including missed calls, received calls and dialed calls is displayed on the home screen 11. Referring to FIG. 4c, the messaging menu is displayed on the user interface of the home screen 11 when message icon is selected. For example, the messaging menu may include that a number of sent messages is five, and a number of received messages is eight.

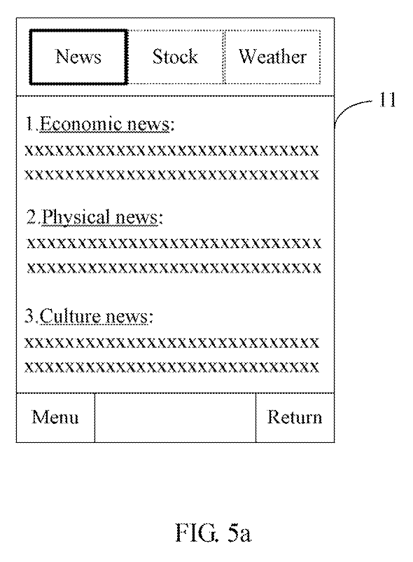

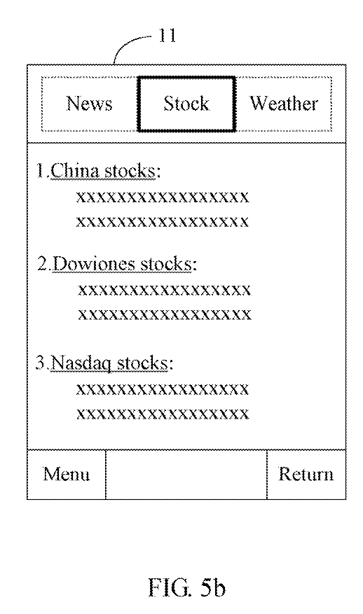

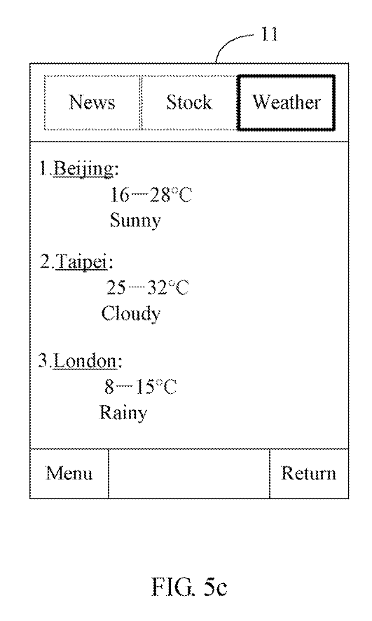

FIG. 5a-5c show schematic diagrams illustrating another example of a user interface displayed on the home screen 11 of the mobile device 1. In the example, the mobile device 1 may synchronously execute a news widget, a stock widget, and a weather widget. Therefore, a set of application icons, including a news icon, a stock icon, and a weather icon, are displayed on the user interface of the home screen 11.

Referring to FIG. 5a, when a user selects the news icon on a first display area (e.g., display area G shown in FIG. 2b) of the user interface of the home screen 11, the news widget downloads related news from a website, and displays the related news on another display area of the user interface, such as display area J shown in FIG. 2b. The related news may include economic news, physical news, and culture news, for example. Referring to FIG. 5b, when the user selects the stock icon on a second display area (e.g., display area H shown in FIG. 2b) of the user interface of the home screen 11, the stock widget downloads stock data from a website, and displays the stock data on the display area J shown in FIG. 2b. The stock data may include China stock data, Dow Jones stock data or Nasdaq stock data, for example. Referring to FIG. 5c, when the user selects the weather icon on a third display area (e.g., I display area shown in FIG. 2b) of the user interface of the home screen 11, the weather widget downloads weather information from a website, and displays the weather information on the display area J shown in FIG. 2b. The weather widget can provide the current weather as well as weather information for the next four days of the week of different cities, such as Beijing, Taipei, and London, for example. The user can select a desired city to get the weather information of the city. After selecting the city, the weather widget automatically connects to the Internet via WLAN or GPRS and downloads weather information of the current day and the next four days of the week.

The mobile device 1 provides an improved user interface that includes a set of groups of horizontal and vertical menu items, which can be both customizable and extensible to allow a user to access and share data and tasks relevant to a particular user. The set of groups can provide the user with a converged view to active and combine data and function between different software applications. Therefore, the user interface will make the user to easily access and share to subset of different data and tasks available on the mobile device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile device, comprising:
a processor operable to initialize a home screen of a display of the mobile device, the processor further operable to initialize a keypad of the mobile device, and execute multiple software applications through an operating system of the mobile device;
a key input unit operable to receive an input command from the keypad, and send the input command to the processor to generate a key input event;
a display output unit operable to generate a user interface on the home screen, divide the user interface into a plurality of display areas according to a total number of the executed software applications, and display an execution result of each of the executed software applications on one of the display areas; and
a task management module operable to support a multitasking environment to execute the multiple software applications synchronously, and control one of the software applications to communicate with the other software applications according to the key input event.

2. The mobile device according to claim 1, wherein the plurality of display areas are arranged on the user interface horizontally, vertically, or both horizontally and vertically.

3. The mobile device according to claim 1, wherein the software applications are main applications that comprise a phonebook application, a message application, a call application, and a display application.

4. The mobile device according to claim 1, wherein the software applications are widget applications that comprise a clock widget, a calendar widget, a weather widget, a news widget, and a stock widget.

5. The mobile device according to claim 4, wherein each of the widget applications is directly downloaded from a website, or is programmed using a programming language.

6. The mobile device according to claim 4, wherein each of the widget applications is customizable and extensible to allow a user to access and share data or tasks provided by the mobile device.

7. A method for operating a user interface of a mobile device, the method comprising:
initializing the mobile device to support a multitasking environment;
synchronously executing multiple software applications in the multitasking environment;
generating a user interface on a home screen of a display of the mobile device;
dividing the user interface into a plurality of display areas according to a total number of the executed software applications;
receiving an input command from a keypad of the mobile device, and generating a key input event according to the input command;
controlling one of the software applications to communicate with the other software applications according to the key input event; and
displaying an execution result of each of the executed software applications on a corresponding display area of the user interface.

8. The method according to claim 7, wherein the plurality of display areas are arranged on the user interface horizontally, vertically, or both horizontally and vertically.

9. The method according to claim 7, wherein the software applications are main applications that comprise a phonebook application, a message application, a call application, and a display application.

10. The method according to claim 7, wherein the software applications are widget applications that comprise a clock widget, a calendar widget, a weather widget, a news widget, and a stock widget.

11. The method according to claim 10, wherein each of the widget applications is directly downloaded from a website, or is programmed using a programming language.

12. The method according to claim 10, wherein each of the widget applications is customizable and extensible to allow a user to access and share data or tasks provided by the mobile device.

13. A storage medium having stored thereon instructions that, when executed by a processor of a mobile device, cause the mobile device to perform a method for operating a user interface of the mobile device, the method comprising:
initializing the mobile device to support a multitasking environment;
synchronously executing multiple software applications in the multitasking environment;
generating a user interface on a home screen of a display of the mobile device;
dividing the user interface into a plurality of display areas according to a total number of the executed software applications;
receiving an input command from a keypad of the mobile device, and generating a key input event according to the input command;
controlling one of the software applications to communicate with the other software applications according to the key input event; and
displaying an execution result of each of the executed software applications on a corresponding display area of the user interface.

14. The storage medium according to claim 13, wherein the plurality of display areas are arranged on the user interface horizontally, vertically, or both horizontally and vertically.

15. The storage medium according to claim 13, wherein the software applications are main applications that comprise a phonebook application, a message application, a call application, and a display application.

16. The storage medium according to claim 13, wherein the software applications are widget applications that comprise a clock widget, a calendar widget, a weather widget, a news widget, and a stock widget.

17. The storage medium according to claim 16, wherein each of the widget applications is directly downloaded from a website, or is programmed using a programming language.

18. The storage medium according to claim 16, wherein each of the widget applications is customizable and extensible to allow a user to access and share data or tasks provided by the mobile device.
